(19) United States
(12) Patent Application Publication
(10) Pub. No.: US 2021/0393370 A1
(43) Pub. Date: Dec. 23, 2021

(54) Dental hand piece for Assisting Measurement

(71) Applicant: Chun Leon CHEN, Taipei City (TW)

(72) Inventors: Chun Leon CHEN, Taipei City (TW); Le Chen CHEN, Las Vegas, NV (US); Sho Chin CHEN, Las Vegas, NV (US); Hong Yui CHEN, Las Vegas, NV (US); Yang How CHEN, Las Vegas, NV (US); Tseu Min CHEN, Las Vegas, NV (US)

(21) Appl. No.: 16/908,751

(22) Filed: Jun. 23, 2020

(51) Int. Cl. A61C 5/44

(52) U.S. Cl. CPC A61C 5/44

(57) ABSTRACT

The present invention provides a dental hand piece for assisting depth measurement comprising a hand piece main body and at least one measuring scale. The hand piece main body has a hand piece head, a joint section and a holding section; a drill is engaged with the hand piece head; and the joint section is connected to the hand piece head and the holding section. The at least one measuring scale is disposed on a surface of the hand piece head, and perpendicular or parallel to the drill. Therefore, the dental hand piece for assisting depth measurement provides the dentist with a clear indication of the measuring scale when drilling or grinding, to avoid the problem of excessive or insufficient drilling depth, so as to achieve the stability of the dental implant after the operation.

### (a) TECHNICAL FIELD OF THE INVENTION

The present invention relates to a dental hand piece for assisting depth and angle measurement, and more particularly to a dental hand piece having a measuring scale capable of measuring depth and angle on a hand piece head.

### (b) DESCRIPTION OF THE PRIOR ART

Artificial tooth implants can provide patients with missing teeth to restore esthetic appearance of tooth and chewing function. A dental implant is made of titanium or zirconium dioxide, it is implanted in the patient's oral alveolar bone, and its function similar to the roots of the original teeth. After the dental implant is tightly integrated with the bone, artificial crown is installed on the roots made of titanium or zirconium dioxide. During dental implantation, a dental hand piece engaged with drill must be used for drilling the alveolar bone in the patient's mouth. When drilling, the dentist must first evaluate the patient's dentition, implant size and the depth of a hole. The depth of the drilling will lead to the stability of the implant installation, so when drilling, it is necessary to closely observe the depth of the drill to avoid improper dental implant installation.

Currently, the drill used for drilling bones will be marked with a color scale to distinguish the depth. However, when the dentist is drilling, the color scale for distinguishing the depth will be covered by blood and water, which makes it difficult for the dentist to see clearly during the process; therefore, it increases surgical risk and dentist pressure. Further, when drilling, the dentist must control the drilling depth with a skilled experience. If it is an osteoporosis patient, the drilling force needs a higher precision, and the conventional drills are more likely to cause the problem of excessive or insufficient drilling depth.

Therefore, at present, there is an urgent need for a dental hand piece that assists in depth and angle measurement to improve the above shortcomings and to improve the success rate of dental implants.

### SUMMARY OF THE INVENTION

The main purpose of the present invention is to provide a dental hand piece for assisting depth and angle measurement, so as to provide the dentist with a clear indication of the measuring scale when drilling, grinding, and drilling alveolar bone, to avoid the problem of excessive or insufficient drilling depth, in order to achieve the stability of dental implants.

To achieve the above object, the present invention provides a dental hand piece for assisting depth and angle measurement comprising a hand piece main body and at least one measuring scale; wherein the hand piece main body has a hand piece head, a joint section and a holding section, a drill is engaged with the hand piece head, and the joint section is connected to the hand piece head and the holding section. Further, the at least one measuring scale disposed on a surface of the hand piece head, and perpendicular or parallel to the drill.

In some embodiments, the measuring scale comprises at least one first measuring scale and at least one second measuring scale, the at least one first measuring scale and the at least one second measuring scale are perpendicular to each other.

In some embodiments, a surface of the hand piece head has a reference line which is parallel to the at least one first measuring scale and perpendicular to the at least one second measuring scale.

In some embodiments, the at least one first measuring scale is disposed around the hand piece head.

In some embodiments, the drill has at least one third scale which is parallel to the least one first measuring scale and disposed around the drill.

In some embodiments, the dental hand piece for assisting depth and angle measurement further comprises an auxiliary measuring scale which is disposed from a connection between the hand piece head and the joint section and extends to 10˜30% of the length of the joint section.

In some embodiments, the auxiliary measuring scale further comprises at least one fourth scale and at least one fifth scale which are perpendicular to each other.

In some embodiments, the at least one first measuring scale and the at least one second measuring scale are convexly disposed on the surface of the hand piece head.

In some embodiments, the at least one first measuring scale and the at least one second measuring scale are concavely disposed on the surface of the hand piece head.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a schematic view of a dental hand piece for assisting measurement according to Embodiment 1 of the present invention;

FIG. 1B is a schematic view of a dental hand piece for assisting measurement according to Embodiment 2 of the present invention;

FIG. 2 is a schematic view of a dental hand piece for assisting measurement according to Embodiment 3 of the present invention;

FIG. 3 is a schematic view of the use of a dental hand piece for assisting measurement according to Embodiment 4 of the present invention;

FIG. 4 is a schematic view of the use of a dental hand piece for assisting measurement according to Embodiment 5 of the present invention;

FIG. 5 is a schematic view of the use of a dental hand piece for assisting measurement according to Embodiment 6 of the present invention;

FIG. 6a is a side view of a dental hand piece for assisting measurement according to Embodiment 7 of the present invention;

FIG. 6b is a side view of a dental hand piece for assisting measurement according to Embodiment 8 of the present invention; and

FIG. 7 is a side view of a dental hand piece for assisting measurement according to Embodiment 9 of the present invention.

### DETAILED DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

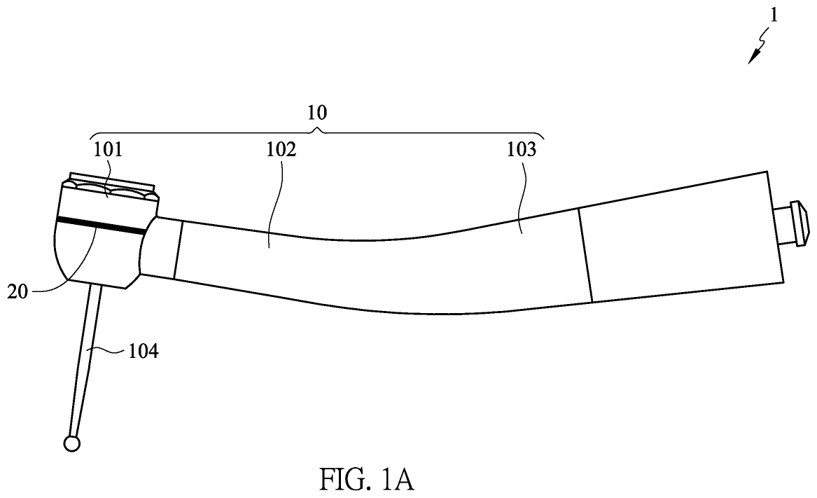

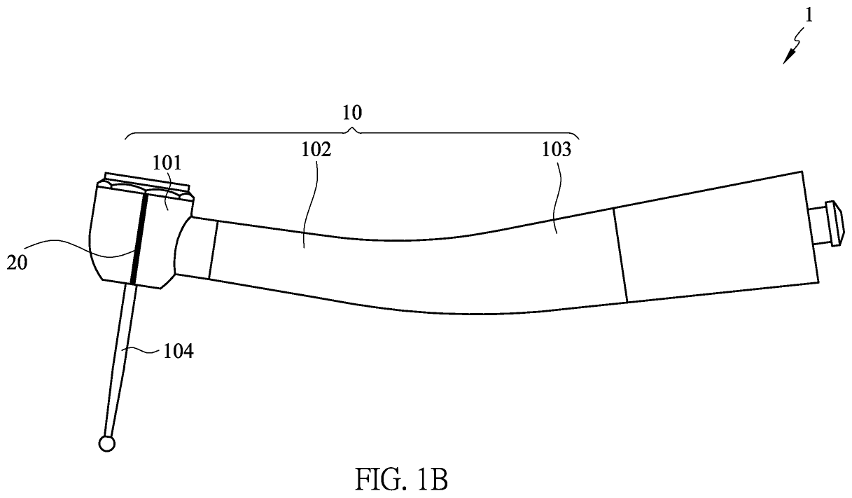

Please refer to FIG. 1A, FIG. 1A is a schematic view of a dental hand piece for assisting measurement according to Embodiment 1 of the present invention.

As shown in FIG. 1 A, the present invention provides a dental hand piece 1 for assisting depth and angle measurement comprising a hand piece main body 10 and at least one measuring scale 20; wherein the hand piece main body 10 has a hand piece head 101, a joint section 102 and a holding section 103, a drill 104 is engaged with the hand piece head 101, and the joint section 102 is connected to the hand piece head 101 and the holding section 103. Further, the at least one measuring scale 20 is disposed on a surface of the hand piece head 101, and perpendicular to the drill 104.

The measurement scale mentioned in the present invention can include straight lines, points, concave points, convex points and so on, which can be used as marks, they are all within the scope of the present invention. The above are only used for illustration, but the present invention is not limited thereto.

Please refer to FIG. 1B, FIG. 1B is a schematic view of a dental hand piece for assisting measurement according to Embodiment 2 of the present invention.

As shown in FIG. 1 B, the structure of Embodiment 2 is substantially the same as the dental hand piece for assisting depth measurement described in Embodiment 1, except that the measuring scale 20 of Embodiment 2 is disposed on the hand piece head 101 and is parallel to the drill 104.

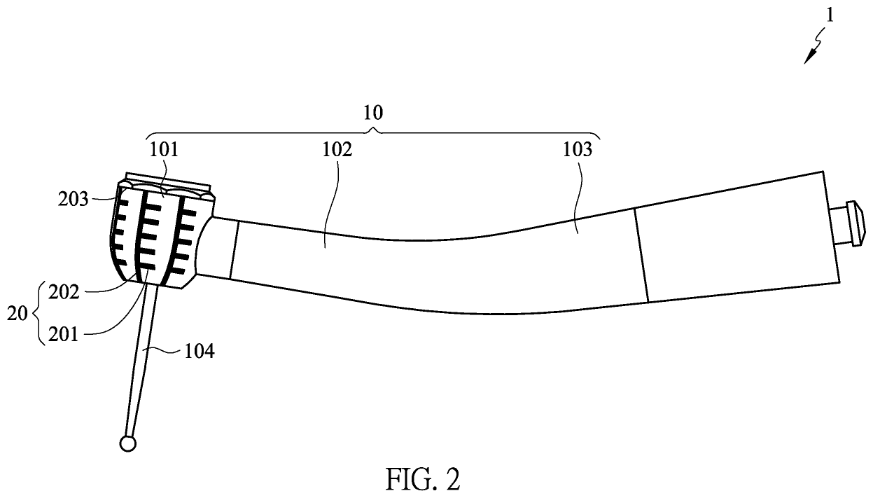

Please refer to FIG. 2, FIG. 2 is a schematic view of a dental hand piece for assisting measurement according to Embodiment 3 of the present invention.

As shown in FIG. 2, the present invention provides a dental hand piece 1 for assisting depth and angle measurement comprising a hand piece main body 10 and at least one measuring scale 20; wherein the hand piece main body 10 of the present invention is the same as the general dental hand piece, and comprises the hand piece head 101, the joint section 102 and the holding section 103 for holding by a dentist's hand. Further, the drill 104 is engaged with the hand piece head 101 which is used for drilling, grinding, and drilling alveolar bone, and the joint section 102 is connected to the hand piece head 101 and the holding section 103. Furthermore, the measuring scale 20 is disposed on a surface of the hand piece head 101; the measuring scale 20 comprises at least one first measuring scale 201 and at least one second measuring scale 202; and the first measuring scale 201 and the second measuring scale 202 are perpendicular to each other; wherein a surface of the hand piece head 101 has a reference line 203 which is parallel to the first measuring scale 201 and perpendicular to the second measuring scale 202. Therefore, the dentist determines the drilling depth of the alveolar bone or grinding teeth based on the first measuring scale 201 and the second measuring scale 202.

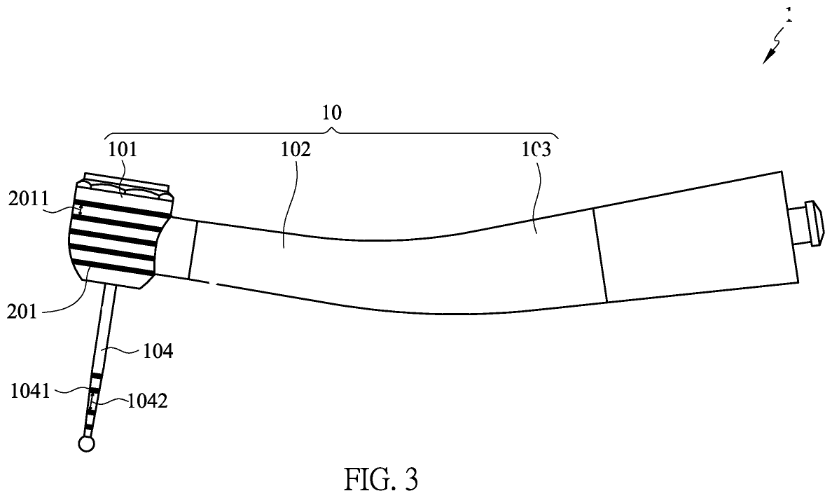

Please refer to FIG. 3, FIG. 3 is a schematic view of the use of a dental hand piece for assisting measurement according to Embodiment 4 of the present invention.

As shown in FIG. 3, the structure of Embodiment 4 is substantially the same as the dental hand piece for assisting depth and angle measurement described in Embodiment 3, except that the second measuring scale is not disposed on the hand piece head 101, and the first measuring scale 201 is disposed around the surface of the hand piece head 101, so that the dentist can clearly see the first measuring scale 201 at different angles during the process of drilling or grinding teeth. Further, third scale 1041 is disposed on the drill 104, the third scale 1041 is parallel to the first measuring scale 201 and disposed around the surface of the drill 104. The dentist can also judge the depth of drilling alveolar bone or the grinding teeth based on the third scale 1041.

Furthermore, as shown in FIG. 3, at least one first vertical interval 1042 is formed between two adjacent the third scales 1041, and at least one second vertical interval 2011 is formed between two adjacent the first measuring scales 201, and the first vertical interval 1042 corresponds to the second vertical interval 2011. That is to say, the size of the first vertical interval 1042 near the tip of the drill 104 is equal to the size of the second vertical distance 2011 on the hand piece head 101. Further, the size of the first vertical interval 1042 between the adjacent third scales 1041 is equal to each other, and the size of each second vertical interval 2011 between the adjacent first scales 201 is equal to each other. In another aspect, the size of first vertical space 1042 1042 between the adjacent third scales 1041 is not equal to each other, and the size of second vertical space 2011 between the adjacent first scales 20 is not equal to each other.

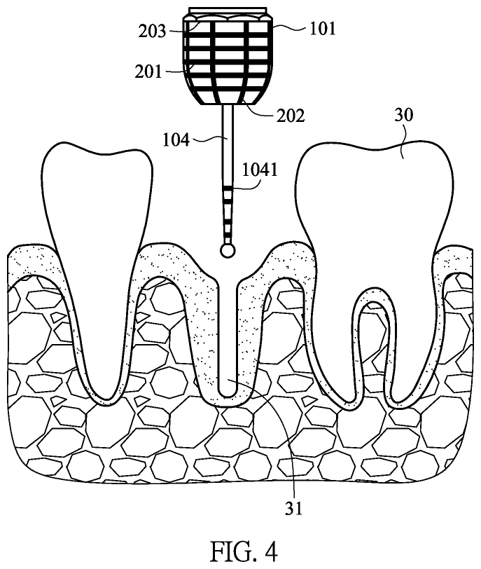

Please refer to FIG. 4, FIG. 4 is a schematic view of the use of a dental hand piece for assisting depth measurement according to Embodiment 5 of the present invention.

As shown in FIG. 4, the structure of Embodiment 5 is substantially the same as the dental hand piece for assisting measurement described in Embodiment 3, except that the first measuring scale 201 is disposed around the surface of the hand piece head 101. When the oral alveolar bone has no teeth and is drilled to insert the dental implant, the oral alveolar bone may atrophy between the teeth due to the lack of teeth, and when the dentist uses the dental hand piece for assisting depth measurement 1 of the present invention to drill a hole 31, the first measuring scale 201 and the second measuring scale 202 are conveniently used for the dentist to judge, so that the drill 104 correctly drills the hole 31 perpendicular to the occlusal surface on the oral alveolar bone, and the hole 31 is used for the dental implant to be correct insertion, thereby improving the success rate of operation.

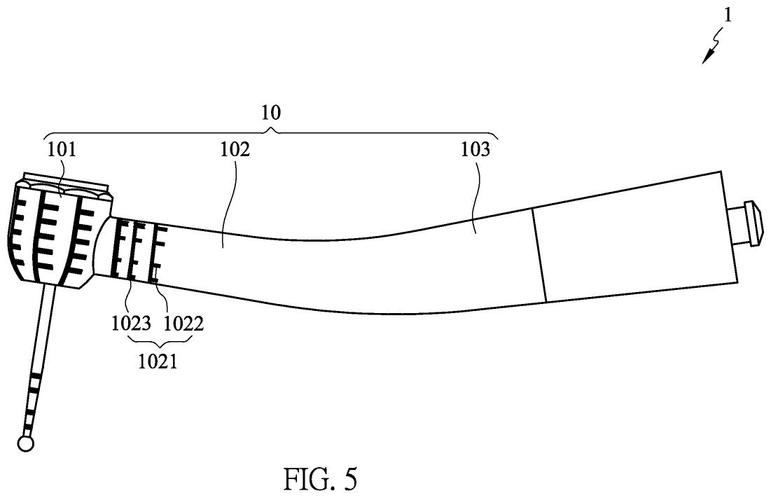

Please refer to FIG. 5, FIG. 5 is a schematic view of the use of a dental hand piece for assisting measurement according to Embodiment 6 of the present invention.

As shown in FIG. 5, the dental hand piece for assisting measurement of the invention further comprises an auxiliary measuring scale 1021 which is disposed from the connection between a hand piece head 101 and the joint section 102 and extends to 10˜30% of the length of the joint section 102; wherein the auxiliary measuring scale 1021 further comprises fourth scale 1022 and a fifth scale 1023 which are perpendicular to each other. Furthermore, during the dental implantation process, when teeth 30, the third scale 1041 on the drill 104 and the first measuring scale 201 and the second measuring scale 202 on the hand piece head 101 will be covered by blood and water, the dentist can judge the drilling depth of the alveolar bone by the fourth scale 1022 and the fifth scale 1023 on the auxiliary measurement 1021.

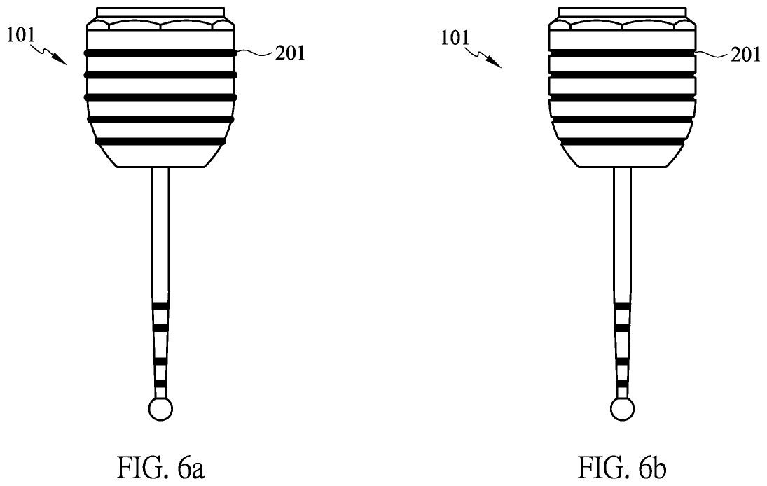

Please refer to FIGS. 6a to 6b, FIG. 6a is a side view of a dental hand piece for assisting measurement according to Embodiment 7 of the present invention; and FIG. 6b is a side view of a dental hand piece for assisting measurement according to Embodiment 8 of the present invention.

As shown in FIG. 6a, the structure of Embodiment 7 is substantially the same as the dental hand piece for assisting depth measurement described in Embodiment 4, except that the first measuring scale is convexly disposed on the surface of the hand piece head. When the dentist performs the drilling, the blood and water will fill the patient's mouth, and the blood and water will cover the first measuring scale 201. Therefore, when the first measuring scale are convexly disposed on the surface of the hand piece head 101, the dentist can see the protrusions of the first measuring scale 201 at different angles to assist the dentist with drilling.

As shown in FIG. 6b, the structure of Embodiment 8 is substantially the same as the dental hand piece for assisting depth measurement described in Embodiment 4, except that the at least one first measuring scale is concavely disposed on the surface of the hand piece head. When the dentist performs the drilling, the blood and water are splashed on the first measuring scale 201. Further, the first measuring scale 201 is not a flat surface but is formed by many concave surfaces; therefore, the reflection of light can be avoided, and the first measuring scale 201 can be clearly seen to facilitate the judgment of the drilling depth of the alveolar bone, the drill 104 can correctly drill the hole 31 perpendicular to the occlusal surface on the oral alveolar bone.

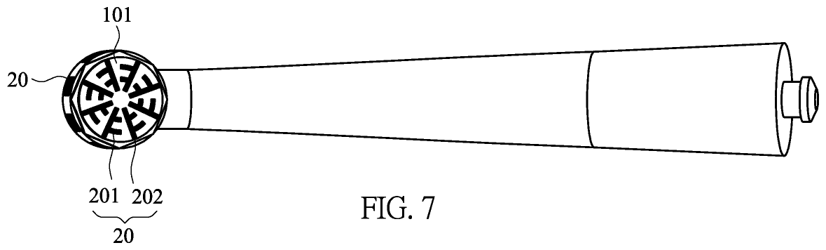

Please refer to FIG. 7, FIG. 7 is a side view of a dental hand piece for assisting measurement according to Embodiment 9 of the present invention.

As shown in FIG. 7, the structure of Embodiment 9 is substantially the same as the dental hand piece for assisting depth measurement described in Embodiment 3, except that the measuring scale 20 is disposed on a top surface of the hand piece head 101, and comprises the first measuring scale 201 and the second measuring scale 202; wherein the first measuring scale 201 and the second measuring scale 202 are perpendicular to each other.

The foregoing description, for the purpose of explanation, has been described with reference to specific embodiments; however. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the disclosure to the precise forms disclosed. Modifications and variations are possible in view of the above teachings.

I claim:

1. A dental hand piece for assisting depth measurement, comprising:
a hand piece main body having a hand piece head, a joint section and a holding section, a drill engaged with the hand piece head, and the joint section connected to the hand piece head and the holding section;
at least one measuring scale disposed on a surface of the hand piece head, and the at least one measuring scale is perpendicular or parallel to the drill.

2. The dental hand piece mentioned in claim 1, wherein the measuring scale comprises at least one first measuring scale and at least one second measuring scale, the at least one first measuring scale and the at least one second measuring scale are perpendicular to each other.

3. The dental hand piece mentioned in claim 2, wherein a surface of the hand piece head has a reference line which is parallel to the at least one first measuring scale and perpendicular to the at least one second measuring scale.

4. The dental hand piece mentioned in claim 2, wherein the at least one first measuring scale is disposed around the hand piece head.

5. The dental hand piece mentioned in claim 1, wherein the drill has at least one third scale which is parallel to the least one first measuring scale and disposed around the surface of the drill.

6. The dental hand piece mentioned in claim 1, further comprising an auxiliary measuring scale which is disposed from a connection between the hand piece head and the joint section and extends to 10˜30% of the length of the joint section.

7. The dental hand piece mentioned in claim 6, wherein the auxiliary measuring scale further comprises at least one fourth scale and at least one fifth scale which are perpendicular to each other.

8. The dental hand piece mentioned in claim 2, wherein the at least one first measuring scale and the at least one second measuring scale are convexly disposed on the surface of the hand piece head.

9. The dental hand piece mentioned in claim 2, wherein the at least one first measuring scale and the at least one second measuring scale are concavely disposed on the surface of the hand piece head.
